(19) United States
(12) Patent Application Publication
(10) Pub. No.: US 2013/0163259 A1
(43) Pub. Date: Jun. 27, 2013

(54) Surface Mount LED Support with Metallic Reflective Cavity

(71) Applicants: Xiaoming Pei, Shenzhen (CN); Weichao Wu, Shenzhen (CN); Zhen Li, Shenzhen (CN)

(72) Inventors: Xiaoming Pei, Shenzhen (CN); Weichao Wu, Shenzhen (CN); Zhen Li, Shenzhen (CN)

(73) Assignee: SHENZHEN LUMING SEMICONDUCTOR LIGHTING CO., LTD., Shenzhen City (CN)

(21) Appl. No.: 13/484,279

(22) Filed: May 31, 2012

(30) Foreign Application Priority Data
Dec. 23, 2011 (CN) 201110438987.1

(51) Int. Cl. F21V 7/20; B29D 11/00; F21V 7/04

(52) U.S. Cl. 362/345; 362/350; 264/1.9

(57) ABSTRACT

A surface mount LED support with metallic reflective cavity includes a plastic frame member and a metallic frame member, wherein the LED support comprises a metallic reflector member which is constructed into a metallic reflector cup-member having a concave cavity. The metallic reflector member includes a bottom metallic plate and a side metallic plate constructing the concave cavity of the metallic cup-member. The side metallic plate is integrally formed by folding the bottom metallic plate. The metallic reflector cup-member has an inner surface coated with a highly reflective material. The LED support of the present invention has high light extraction efficiency, superior cooling capacity and wide range of use of power.

### BACKGROUND OF THE PREVENT INVENTION

1. Field of Invention

The present invention relates to a LED support, and more particularly to a surface mount LED support with metallic reflective cavity.

2. Description of Related Arts

Conventional surface mount (SMD) LED support has a compact size and simple structure which is suitable for mass production by automatic machinery. In addition, it is possible to utilizing reflow soldering during processing. Accordingly, SMD LED support is widely used in semiconductor lighting. However, the conventional LED support has relatively low light extraction efficiency, poor cooling capacity and narrow range of use of power because of its plastic body construction of LED reflector cup and its limited heat sink area.

### SUMMARY OF THE PRESENT INVENTION

An object of the present invention is to provide a surface mount LED support with metallic reflective cavity which has high light extraction efficiency, superior cooling capacity and wide range of use of power.

Additional advantages and features of the invention will become apparent from the description which follows, and may be realized by means of the instrumentalities and combinations particular point out in the appended claims.

According to the present invention, the foregoing and other objects and advantages are attained by a surface mount LED support with metallic reflective cavity, comprising:

a plastic frame member and a metallic frame member which are arranged for forming a reflector member which has a metallic reflective cavity construction.

Preferably, the reflector member is a reflector cup-member which comprises a bottom metallic plate and a side metallic plate for constructing a concave cavity.

Preferably, the side metallic plate is integrally formed by folding the bottom metallic plate.

Preferably, the reflector member has an inner surface which is coated with a layer of highly reflective material.

Compared to conventional LED support or frame, the present invention has the following advantageous effect:

The LED support according to the preferred embodiment of the present invention is mainly constructed by the metallic frame member, while the chip carrier and the circuit carrier of the entire LED support is supported by the metallic frame member. The reflector member, namely the reflector cup-member, has a metallic cavity construction which has a layer of highly reflective material coated onto its inner surface, thereby the light extraction efficiency of the entire LED support is very high. The metallic frame member serves as a chip carrier, therefore the heat dissipation channel of the chip is short and the heat dissipation capability is very high. Compared to a conventional SMD LED support, the LED support accordingly to the preferred embodiment of the present invention has a large heat sink area which is not only provided through the bottom portion of the LED support, but also through the metallic cup-member of the metallic frame member. Accordingly, the heat sink capacity of the entire

LED support is increased, the power applicability is increased, and the range of use of power is increased widened. In addition, since the metallic reflector cup member is formed by the metallic frame member made in metallic material, the problem of yellowing of plastic reflector cup in the conventional LED support through which the luminous flux is dramatically decreased will not occurred in the LED support of the present invention. Accordingly, the LED support according to the preferred embodiment of the present invention not only provides the advantageous effect of the conventional surface mount LED support, which is compact in size, simple in construction, suitable for mass production by automatic equipment through fully automatic process and applicable for reflow soldering during, but also provides additional features of enhanced and increased light extraction efficiency and superior cooling capacity, thereby promoting further development of utilization of surface mount LED in a wide range of application areas

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a front view illustration of a surface mount LED support with metallic reflective cavity according to a preferred embodiment of the present invention.

FIG. 2 is a rear view illustration of a surface mount LED support with metallic reflective cavity according to the above preferred embodiment of the present invention.

### DETAILED DESCRIPTION OF THE PREFERRED EMBODIMENT

The surface mount LED support with metallic reflective cavity according to the preferred embodiment of the present invention is further described with the accompanying drawings as follows.

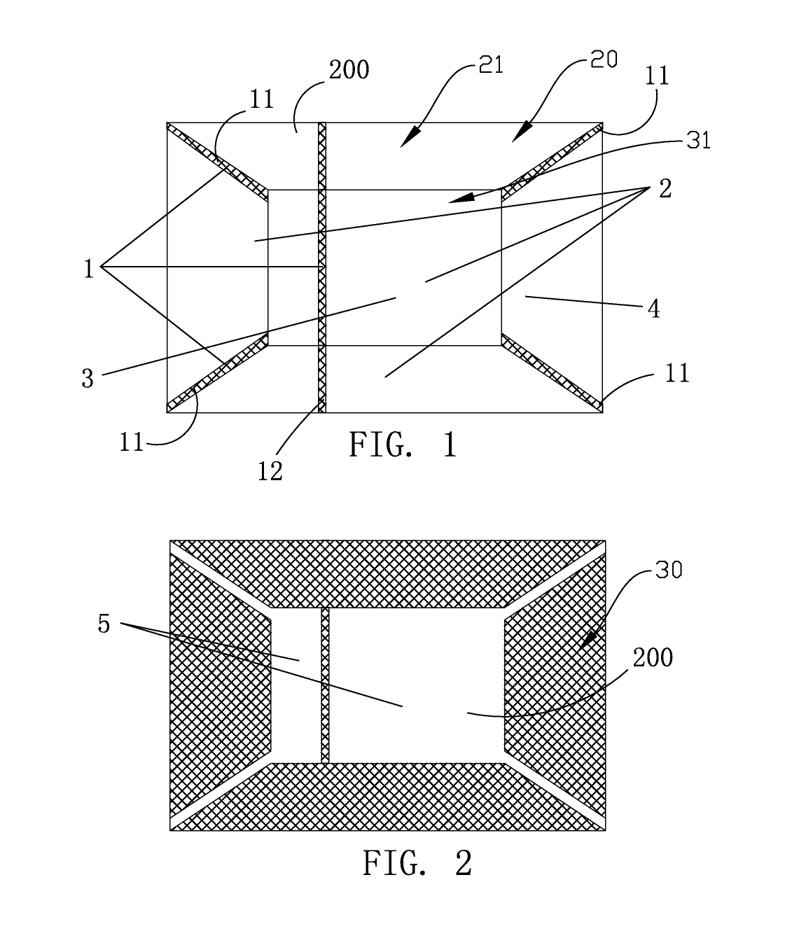

Referring to FIGS. 1 and 2 of the drawings, the surface mount LED support with metallic reflective cavity according to the preferred embodiment of the present invention comprises a first frame member 1 and a second frame member, wherein the first frame member 1 is a plastic frame member and the second frame member is a metallic frame member having a metallic reflector member 2. The metallic reflector member 2 has a cup-shaped construction. In other words, the metallic reflector member 2 is a metallic reflector cup-member. The metallic reflector member 2 comprises a bottom panel 3 and a side panel 4, which are bottom metallic plate and side metallic plate respectively, arranged for constructing a concave cavity. The side panel 4 is integrally formed by folding the bottom panel 3. In other words, the bottom metallic plate 3 is folded to form the side metallic plate 4. The metallic reflector member 2 has an inner surface coated with a layer of highly reflective material. The LED support forms its skeleton by the metallic frame member of the LED support and is formed by injection molding. The shape, dimension and structural construction of the LED support are capable of having a plurality of designs. That is to say, based on the need or requirement of the LED support, the shape, dimension and structural construction can have different designs or customized. Accordingly, the design flexibility in relation to shape, dimension and structural construction is very high. The metallic reflector member 2 has a bottom portion arranged for serving as a LED chip carrier as well as a lead pad for the chip. The bottom portion can also be used for the LED support to connect to a circuit pad 5. The side panel 4 of the metallic reflector member 2 is integrally formed by folding the bottom panel 3, therefore the entire metallic reflector member 2 includes minimized plastic materials in the bottom panel 3 and the side panel 4. In other words, through the construction of the side metallic plate by folding the bottom metallic plate, the portion of plastic material on a front side 20 of the LED support is minimized. Accordingly, the process of coating highly reflective material is facilitated effectively while the light extraction efficiency of the metallic reflective cavity of the surface mount LED support is effectively increased. Compared to a conventional SMD or surface mount LED support, the surface area of the metallic portion of the entire LED support according to the present invention has dramatically increased, thereby effectively increasing the cooling capacity of the LED support of the present invention while broadening the use of power to a higher power range. The LED support according to the preferred embodiment of the present invention not only provides the advantageous effect of the conventional surface mount LED support, which is compact in size, simple in construction, suitable for mass production by automatic equipment through fully automatic process and applicable for reflow soldering during, but also provides additional features of enhanced light extraction efficiency and superior cooling capacity, thereby promoting further development of utilization of surface mount LED in a wide range of application areas.

In other words, referring to FIGS. 1 and 2 of the drawings, the present invention provides a LED support arranged for housing a surface mount type LED, comprising: a plastic frame member 1; and a metallic frame member 200 integrally connected to the plastic frame member 1 in such a manner that the metallic frame member 200 forms a reflector member 2 having a metallic reflective cavity construction in a front side 20 of the LED support, thereby the front side 20 of the LED support is mainly constructed by the reflector member 2 for providing a reflective surface so as to increasing a light extraction efficiency and a cooling capacity while broadening a power range applicability through providing the LED support.

In particular, the metallic frame member 200 and the plastic member 1 are integrally formed by injection molding in such a manner that the reflector member 2 of the metallic frame member 200 further defines a bottom panel 3 and a side panel 4 extended from the bottom panel 3, wherein the plastic frame member 1 is provided to the bottom panel 3; and to the side panel 4 arranged for providing a plurality of folding junctions 11 such that the side panel 4 is capable of being folded through the folding junctions 11 to transversely and peripherally extended from the bottom panel 3 for constructing the metallic reflective cavity in the front side 20 of the LED support. The metallic reflector member 2 has an inner surface on the front side 20 of the LED support which is coated with a highly reflective material.

Preferably, as shown in FIGS. 1 and 2 of the drawings, the metallic reflective cavity is a concave cavity having a trapezoid cross-section. The plastic frame member 1 defines a plastic portion 12 extended along two sides of the LED support and four folding junctions 11 on the side panel 4.

It is worth mentioning that the bottom panel 3 of the metallic reflector member 2 further defines a bottom portion 31 arranged for carrying a LED chip of the LED while serving as a lead pad for the LED such that the LED support is capable of connecting to a circuit pad 5 through the bottom portion 31 of the metallic reflector member 2.

Accordingly, the LED support is manufactured by an automatic process comprising the steps of: (a) providing the metallic frame member 200; (b) providing the plastic frame member 1 to the metallic frame member 200 by injection molding and defining the metallic reflector member 2 on a front side 20 of the LED support; and (c) folding the metallic reflector member 2 of the metallic frame member 200 to form the metallic reflective cavity. Preferably, the automatic process further comprises the step of: coating the highly reflective material onto the front side 20 of the LED support through the metallic reflector member 2.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A metallic reflective cavity of a surface mount LED support which comprises a plastic frame member and a metallic frame member, characterized in that:
the LED support comprises a metallic reflector member which is constructed into a metallic reflector cup-member having a concave cavity.

2. The metallic reflective cavity of a surface mount LED support, as recited in claim 1, wherein said metallic reflector member comprises a bottom metallic plate and a side metallic plate arranged for constructing into said concave cavity of said metallic cup-member.

3. The metallic reflective cavity of a surface mount LED support, as recited in claim 2, wherein said side metallic plate is integrally formed by folding said bottom metallic plate.

4. The metallic reflective cavity of a surface mount LED support, as recited in claim 2, wherein said metallic cup-member has an inner surface coated with a highly reflective material.

5. A LED support arranged for housing a surface mount type LED, comprising:
a plastic frame member; and
a metallic frame member integrally connected to said plastic frame member in such a manner that said metallic frame member forms a reflector member having a metallic reflective cavity construction in a front side of said LED support,
thereby said front side is mainly constructed by said reflector member for providing a reflective surface so as to increasing a light extraction efficiency and a cooling capacity while broadening a power range applicability through providing said LED support.

6. The LED support, as recited in claim 5, wherein said metallic frame member and said plastic frame member are integrally formed by injection molding in such a manner that said metallic frame member further defines a bottom panel and a side panel extended from said bottom panel, wherein said plastic frame member is provided to said bottom panel and to said side panel arranged for providing a plurality of folding junctions such that said side panel is capable of being folded through said folding junctions to transversely and peripherally extended from said bottom panel for constructing said metallic reflective cavity in said front side of said LED support.

7. The LED support, as recited in claim 6, wherein said metallic reflective cavity is a concave cavity having a trapezoid cross-section.

8. The LED support, as recited in claim 6, wherein said bottom panel of said metallic frame member further defines a bottom portion arranged for carrying a LED chip of the LED while serving as a lead pad for the LED such that said LED support is capable of connecting to a circuit pad through said bottom portion of said metallic frame member.

9. The LED support, as recited in claim 7, wherein said bottom panel of said metallic frame member further defines a bottom portion arranged for carrying a LED chip of the LED while serving as a lead pad for the LED such that said LED support is capable of connecting to a circuit pad through said bottom portion of said metallic frame member.

10. The LED support, as recited in claim 9, wherein said plastic frame member defines a plastic portion extended along two sides of said LED support and four folding junctions on said side panel.

11. The LED support, as recited in claim 9, wherein said metallic reflector member has an inner surface on side front side of the LED support which is coated with a highly reflective material.

12. The LED support, as recited in claim 10, wherein said metallic reflector member has an inner surface on side front side of the LED support which is coated with a highly reflective material.

13. The LED support, as recited in claim 11, wherein said LED support is manufactured by an automatic process comprising the steps of:
(a) providing said metallic frame member;
(b) providing said plastic frame member to said metallic frame member by injection molding and defining the metallic reflector member of the metallic frame member; and
(c) folding said metallic reflector member to form said metallic reflective cavity.

14. The LED support, as recited in claim 12, wherein said LED support is manufactured by an automatic process comprising the steps of:
(a) providing said metallic frame member;
(b) providing said plastic frame member to said metallic frame member by injection molding and defining the metallic reflector member of the metallic frame member; and
(c) folding said metallic reflector member to form said metallic reflective cavity.

15. The LED support, as recited in claim 13, wherein said automatic process further comprises the step of: coating the highly reflective material onto said front side of said LED support through said metallic reflector member.

16. The LED support, as recited in claim 14, wherein said automatic process further comprises the step of: coating the highly reflective material onto said front side of said LED support through said metallic reflector member.
